(19) United States
(12) Patent Application Publication
(10) Pub. No.: US 2009/0195702 A1
(43) Pub. Date: Aug. 6, 2009

(54) Time-delayed full standby mode for consumer electronic devices

(75) Inventor: Matthew A. Eshleman, Mount Juliet, TN (US)

Correspondence Address: NIXON & VANDERHYE, PC, 901 NORTH GLEBE ROAD, 11TH FLOOR, ARLINGTON, VA, 22203, US

(73) Assignee: Toshiba America Consumer Products, LLC, Wayne, NJ (US)

(21) Appl. No.: 12/318,757

(22) Filed: Jan. 7, 2009

Related U.S. Application Data
(60) Provisional application No. 61/006,316, filed on Jan. 7, 2008.

(51) Int. Cl. H04N 5/63

(52) U.S. Cl. 348/730; 348/E05.127

(57) ABSTRACT

Example systems and methods for powering down a consumer electronic device such as a television provide for an ON state, a partial standby state and a full standby state. The ON state is when the television is fully powered ON, as when a user is watching television. In the partial standby state, the display is powered OFF, but all CPUs and tuners are still powered. In the full standby state, nearly all circuits, tuners, CPUs and the like are powered OFF. Only the infrared receiver sub-micro and related circuits have power in order to receive power on signals from the remote control.

### CROSS-REFERENCE TO RELATED APPLICATION

This application claims the benefit of provisional U.S. application No. 61/006,316, filed Jan. 7, 2008, the entire contents of which are incorporated herein by reference.

### BACKGROUND AND SUMMARY

The subject application generally relates to systems and methods for reducing power consumption for consumer electronic devices such as televisions.

To reduce power consumption, it is desirable for consumer electronic devices such as televisions to turn off nearly all CPU and digital circuits when the television is in “stand-by” mode. This can however result in longer “stand-by state” to “on state” transition time because of the time needed to turn the circuits on. This longer transition time is however undesirable for, for example, users that accidentally press the remote control POWER key and then must wait additional time for the unit to power on again.

To help with this situation, the systems and methods described herein provide for an ON state, a partial standby state and a full standby state. The ON state is when the television is fully powered ON, as when a user is watching television. In the partial standby state, the display is powered OFF, but all CPUs and tuners are still powered. In the full standby state, nearly all circuits, tuners, CPUs and the like are powered OFF. Only the IR receiver sub-micro and related circuits have power in order to receive power on signals from the remote control. This mode can consume less than 3 watts.

### BRIEF DESCRIPTION OF THE DRAWINGS

FIG. 1 is a highly generalized block diagram of an example television 100 in which the example systems and methods described herein may be implemented.

FIG. 2 provides a more detailed view of example remote control 150 in FIG. 1.

FIG. 3 is an example state diagram showing the ON, partial stand-by and full stand-by states in accordance with the systems and methods described herein.

### DETAILED DESCRIPTION OF EXAMPLE EMBODIMENTS

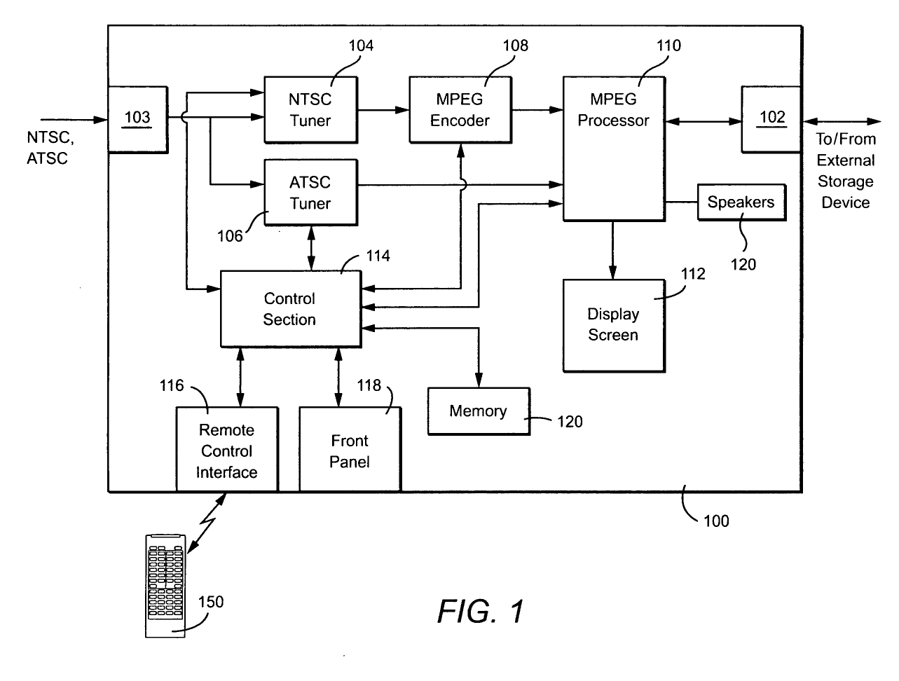

FIG. 1 is a highly generalized block diagram of a television 100 in which the example systems and methods described herein may be implemented. The details of television 100 are provided by way of example only and it will be readily apparent that the systems and methods described herein may be implemented in a wide variety of televisions of different configurations, both analog and digital.

An input 103 of the television receives NTSC and ATSC signals. The NTSC signals are supplied to an NTSC tuner 104 and the ATSC signals are supplied to an ATSC tuner 106. Other inputs (not shown) may also be supplied to the television. For example, the television may receive HDMI signals or the output from a DVD player. The output of NTSC tuner 104 is supplied to an MPEG encoder 108 which MPEG encodes the tuned NTSC signal. The outputs of ATSC tuner 106 and MPEG encoder 108 are supplied to an MPEG AV processor 110. MPEG AV processor 110 processes the MPEG transport stream from the ATSC tuner 106 and/or MPEG encoder 108 and supplies a display signal to display screen 112 and a sound signal to speakers 120. MPEG AV processor 110 also selectively outputs an MPEG transport stream to and receives an MPEG transport stream from an external storage system via interface 102. The external storage system may, for example, include a hard disk drive (HDD) recording device, a DVD recording device, or an HDD/DVD recording device. Generally speaking, MPEG AV processor 110 is a standard processing device used in conventional digital integrated televisions, monitors and set-top box (STB) units that receives MPEG compressed AV data and decompresses and processes the AV data for output via display screen 112 and speakers 120.

A control section 114, including a CPU, for example, controls the overall operations of television 100. In general, control section 114 may include, for example, a microprocessor, a microcontroller, a processor, a controller, an application specific integrated circuit (ASIC), logic circuitry, a state machine and/or combinations thereof. Control section 114 may be supplied with inputs from a user via a remote control interface 1116 (e.g., a wireless infrared receiver) for a remote control 150 (e.g., an infrared remote control) and front panel keys 118. MPEG AV processor 110 may selectively block output of audio and/or video in accordance with control signals from control section 114.

Memory 120, which may be a combination of volatile and non-volatile semiconductor memory, stores various operating programs and user settings (e.g., rating level(s) set by parents) used by control section 114 to control the operation of television 100. For example, memory 120 may include ROM storing an operating program for execution by the control section 114 to implement the systems and methods described herein. This operating program may provide for control of tuners 104, 106; control of MPEG AV processor 110 to generate displays for display on display screen 212 and sounds for output via speakers 120; processing of inputs supplied by a user via front panel 118 and/or remote control 150; and the like. Memory 120 may also include SDRAM for use by control section 114 during execution of the operating program.

Television 100 may also be provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 102). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

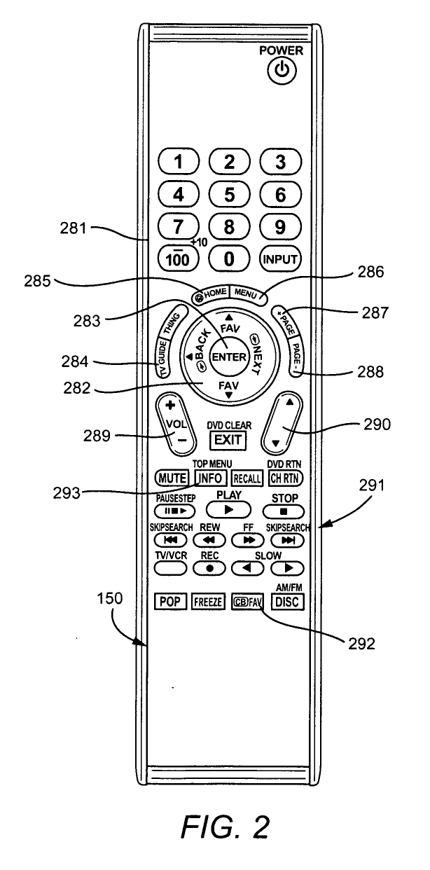

FIG. 2 shows an example layout of keys and buttons for remote control 150. The keys or buttons of remote control 150 may be appropriately labeled to assist the user in selecting a desired function. Alternatively or additionally, television 100 may provide one or more displays that inform the user which key(s) or button(s) should be actuated to input desired commands. Other types of inputs such as voice inputs may also be used to input commands in certain implementations.

Remote control 150 includes a numeric keypad 281 including the numbers 0-9. Keypad 281 also includes a “-/100” key for use in entering channel numbers greater than 100 and a delimiter for separating major and minor channel numbers (e.g., channel 125-3). An “Input” key is provided for use in switching between different inputs to television 100 (e.g., different antennas, different video inputs, different devices connected to the television, etc.). Remote control 150 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel. A “menu” key 286 causes television 200 to display an initial menu screen for accessing various features of television 200. A “Page+” key 287 and a “Page−” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “Fav” key 292 accesses a favorite channel feature. An “Info” key 293 can be pressed by a user to access additional information on a particular topic.

It will of course be appreciated that the function(s) associated with the various keys and buttons of the remote controls described above may vary depending on the state of television 100 (e.g., watching television, moving through menus, making menu selections, etc.). Moreover, the layout of the keys and buttons shown in FIG. 2 is not intended to be limiting in any way and various designs for laying out these keys and buttons may be adopted.

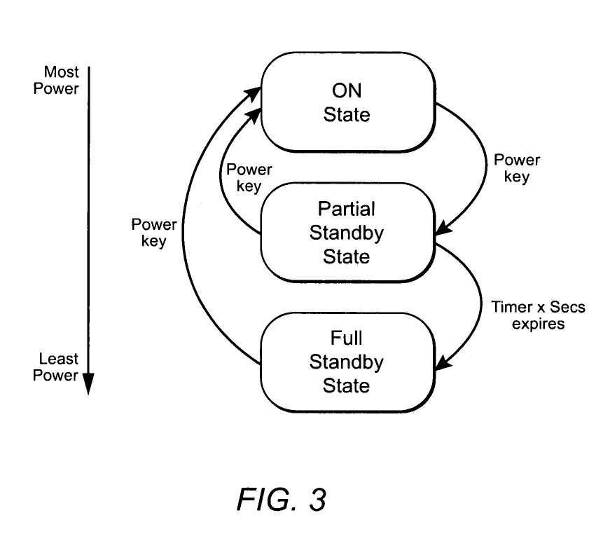

To reduce power consumption, it is desirable for consumer electronic devices such as televisions to turn off nearly all CPU and digital circuits when the television is in “stand-by” mode. This can however result in longer “stand-by state” to “on state” transition time because of the time needed to turn the circuits on. This longer transition time is however undesirable for, for example, users that accidentally press the remote control POWER key and then must wait additional time for the unit to power on again. To help with this situation, a method shown in FIG. 3 may be used in which an ON state, a partial standby state and a full standby state are provided. The ON state is when the television is fully powered ON, as when a user is watching television. In the partial standby state, the display (e.g., an LCD display, a plasma display, a CRT) is powered OFF, but the control section (e.g., all CPUs) and tuners are still powered. The power supply to the components of the television may, for example, be controlled by control section 114 which can selectively connect/remove power to the television components. In the full standby state, nearly all circuits, tuners, control section (e.g., CPUs) and the like are powered OFF. Only the infrared receiver sub-micro and related circuits are powered in order to receive power on signals from remote control 150. This mode can consume less than 3 watts. In response to a power on command received via the wireless infrared receiver, power is supplied to control section 114, which initiates a power-up sequence to place the television in the ON state in which the television is fully powered ON.

As shown in FIG. 3, when the television is in the ON state and the remote control POWER key is pressed, the television proceeds to the partial standby state. After some period of time (e.g. thirty seconds) determined by a timer (e.g., a software timer), the television transitions to the full standby state. If the power key is pressed while the television is in the partial standby mode, there is only a short transition time to the ON state because the control section (e.g., CPU's), tuners, and the like are still powered. Thus, a user who accidentally hits the remote control POWER key when the television is in the ON state does not need to wait for all of the circuits to be powered back on.

The various aspects of the systems and methods described herein may be implemented as part of an operating program executed by control section 114. This program can, for example, be tangibly embodied or stored on a computer-readable medium such as memory 120. Memory 120 may include magnetic memory, optical memory, semiconductor memory, magneto-optic memory, combinations thereof and the like and may, in some instances, be removable memory. In another example, the program may be available for downloading over the internet so that the program may be delivered to television 100 via a communication network. Updates may be provided via downloads to television 100. Further, a carrier wave may be modulated by a signal representing the corresponding program and an obtained modulated wave may be transmitted, so that the television that receives the modulated wave may demodulate the modulated wave to restore the corresponding program.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the spirit and scope of the appended claims.

I claim:

1. A method for powering down a television, the method comprising:
receiving a power off input;
in response to the power off input, powering down a display of the television, but not a control section, a tuner or a wireless receiver thereof;
after a specified time period, powering down the control section and the tuner, but not the wireless receiver.

2. A television comprising:
a display;
a control section;
a tuner; and
a wireless receiver,
wherein the control section is programmed to power down the television in response to a power off input by initially powering off the display, but not the control section, tuner or wireless receiver, and by, after a specified period of time, powering down the control section and the tuner, but not the wireless receiver.

3. A computer-readable medium having program instructions stored therein for execution by a processing system to perform a method of powering down a television, the method comprising:
receiving a power off input;
in response to the power off input, powering down a display of the television, but not a control section, a tuner or a wireless receiver thereof;
after a specified time period, powering down the control section and the tuner, but not the wireless receiver.
